(19) United States
(12) Patent Application Publication
(10) Pub. No.: US 2003/0230945 A1
(43) Pub. Date: Dec. 18, 2003

(54) Brushless motor

(76) Inventors: Masayuki Okubo, Nitta-gun (JP); Yoshiaki Taniguchi, Iruma-gun (JP); Hideaki Fujii, Sawa-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/452,644

(22) Filed: Jun. 3, 2003

(30) Foreign Application Priority Data
Jun. 13, 2002 (JP) 2002-172778

(51) Int. Cl. H02K 7/20

(52) U.S. Cl. 310/112

(57) ABSTRACT

In a brushless motor 1, a rotor 5 is rotatably arranged in the inside of a stator 4 and the rotary position of the rotor 5 can be detected by a resolver 10. The stator 4 includes a stator core 7 around which a drive coil 6 is wound and a case 8. The rotor 5 includes a rotor shaft 2 and a rotor magnet 9. A resolver rotor 27 is rigidly secured to the rotor shaft 2. A resolver mount unit 15 is arranged between the case 8 and a bracket 14 and contains a resolver stator 16. The resolver mount unit 15 is made of synthetic resin and a power supply line coupler 20 and signal line coupler 21 are integrally molded with it and arranged radially relative to the center O of the shaft of the rotor 5. The resolver stator 16 and the resolver mount unit 15 may be integrally molded.

### BACKGROUND OF THE INVENTION

1. Field of the Invention

This invention relates to a brushless motor. More particularly, the present invention relates to a technique that can be effectively applied to a brushless motor to be used for an electric power steering apparatus.

2. Related Art Statement

Generally, in a brushless motor, the rotary position of the rotor is detected by detecting a polar shift of the magnet rotor or the sensor magnet by means of magnetism detection elements such as Hall elements. Then, the currently active stator side excitation coil is switched appropriately to another according to the rotary position of the rotor to form a rotary magnetic flux around the rotor and drive the rotor to revolve. Meanwhile, brushless motors are frequently used as substitutes of motors having a brush so that they are often made to have a structure similar to that of a conventional motor with a brush. For example, the section for drawing out the lead wires of the brushless motor is frequently configured so as to be similar to its counterpart of a motor having a brush. More specifically, an airtight structure using a rubber grommet for drawing out lead wires is frequently used.

However, in the case of a lead wire drawing out structure using a rubber grommet, the operation of fitting lead wires is a cumbersome one, involving a large number of man-hour, while the water-proof arrangement of the lead wire drawing out section is not fully reliable. Additionally, when the signal lines from the magnetism detection elements are located close to the power supply lines in the lead wire drawing out section, the signal lines can be affected by noises produced by the electric currents running through the power supply lines. Particularly, the influence of noise can appear readily in the case of a device that is driven to operate with an intense electric current such as the brushless motor of an electric power steering apparatus (to be referred to simply as EPS hereinafter). What is worse, defective sensing due to noise can significantly damage the feeling of steering on the part of the operator and therefore there is a strong demand for improved brushless motors of the category under consideration.

### SUMMARY OF THE INVENTION

In view of the above identified circumstances, it is therefore an object of the present invention to provide a brushless motor that is advantageous in terms of durability, noise resistance and mounting.

According to the invention, the above object is achieved by providing a brushless motor comprising a core provided with a drive coil wound around it, a stator having a case for containing the core, a bracket arranged at the side of an end of the case, a rotor having a shaft rotatably supported by the case and the bracket and a magnet fitted to the shaft and rotatably arranged in the inside of the stator, a resolver rotor fitted to the shaft and adapted to rotate with the magnet, a resolver stator arranged at the outside of the resolver rotor and having a detection coil adapted to change the phase of its output signal as a function of the revolutions of the resolver rotor and a resolver mount unit made of synthetic resin and arranged between the case and the bracket to contain the resolver stator.

Thus, according to the invention, a brushless motor is formed by using a highly durable and highly noise-resistant resolver and the resolver is unitized and mounted in the motor so that the brushless motor can enjoy an enhanced level of reliability and become down-sized.

In a brushless motor according to the invention, the resolver mount unit may include a main body section made of synthetic resin and held tight betweens the case and the bracket, a first coupler molded integrally with the main body section and provided with a power supply terminal electrically connected to the drive coil and a second coupler molded integrally with the main body section and provided with a signal terminal electrically connected to the resolver stator. With this arrangement, the power supply terminal and the signal terminal are turned into direct couplers that are held between the bracket and the case. Thus, both the power supply lines and the signal lines can be assembled with an enhanced level of reliability and the number of assembling steps can be reduced to by turn reduce the manufacturing cost while the water resistance of the drawing out section is improved and the quality control of the product is facilitated.

Still alternatively, the first coupler and the second coupler may be arranged in respective radial directions relative to the center of the shaft of the rotor. With this arrangement, the influence of the noises coming out of the power supply lines and exerted on the signals in the signal lines can be further reduced.

In a brushless motor according to the invention, the resolver stator and the resolver mount unit, the resolver mount unit and the core, the resolver stator and the bracket and/or the core and the case may be integrally molded. Additionally, the resolver stator, the case, the first coupler provided with the power supply terminal electrically connected to the drive coil and the second coupler provided with the signal terminal electrically connected to the resolver stator may be integrally molded. With this arrangement again, the first coupler and the second coupler may be arranged in respective radial directions relative to the center of the shaft of the rotor.

In a brushless motor according to the invention, the rotary position of the rotor is detected by the resolver that does not involve the use of semiconductor. Therefore, many of the components can be integrally molded in many different ways. Thus, dimensional errors that may be involved in the assembling operation are reduced to remarkably improve the positional accuracy of components including the resolver stator in the brushless motor. Additionally, the productivity of manufacturing brushless motors is improved and the manufacturing cost is lowered because many components are integrally formed and the number of assembling steps is reduced. Still additionally, due to the enhanced degree of integration, the backlash of components is reduced to improve the shockproof of the motor. Furthermore, when the stator core is integrally formed with some other component, it is protected against vibrations so that generation of magnetically distorted sound can be reduced.

In another aspect of the invention, there is provided a brushless motor comprising: a stator provided with a drive coil wound around it, a rotor having a plurality of magnetic poles and arranged rotatably at the outer or inner periphery of the stator, a revolution detection means adapted to output a sensor signal in response to the revolutions of the rotor, power supply lines electrically connected to the drive coil and signal lines electrically connected to the revolution detection means and arranged in a radial direction relative to the center of the shaft of the rotor with an angular gap separating it from the power supply lines.

Thus, according to the invention, the power supply lines and the signal lines are not juxtaposed but arranged in respective radial directions. With this arrangement, the gap separating them is not undesirably reduced so that the influence of the noises generated by the power supply lines on the signals in the signal lines can be reduced. Therefore, rotor position detection errors due to noises are suppressed and the motor can be driven efficiently to consequently reduce the torque ripple.

In a brushless motor according to the invention and having the above described configuration, the power supply lines and the signal lines may be arranged at respective positions that are point-symmetric or rectangular relative to the center of the shaft of the rotor. Preferably, the power supply lines and the signal lines are arranged with an angular gap of not less than 30° separating them from each other.

In a brushless motor according to the invention and having the above described configuration, the revolution detection means may include a resolver rotor that revolves with the rotor and a resolver stator provided with a detection coil adapted to change the phase of its output signal as a function of the revolution of the resolver rotor. Alternatively, the revolution detection means may include a sensor magnet having magnetic poles as many as the number of poles of the rotor and a magnetism detection element for detecting a change in the magnetic poles of the sensor magnet.

A brushless motor according to the invention may be used as motor in an electric power steering apparatus. An electric power steering apparatus that is highly shock-proof and noise-resistant and can enjoy excellent reliability and durability can be provided by using a motor according to the invention. Additionally, according to the invention, it is possible to provide an electric power steering apparatus that has little torque ripple and operates excellently in terms of the feeling of steering due to the reduced noise level of the signal lines.

The above-described and other objects, and novel feature of the present invention will become apparent more fully from the description of the following specification in conjunction with the accompanying drawings.

### BRIEF DESCRIPTION OF THE DRAWINGS

FIG. 1 is a schematic partial cross sectional view of an embodiment of brushless motor according to the invention.

FIG. 2 is a schematic lateral view of the embodiment of brushless motor of FIG. 1.

FIG. 3 is an exploded schematic perspective view of the embodiment of brushless motor of FIG. 1.

FIG. 4 is a schematic illustration of an alternative arrangement of the power supply lines and the signal lines and FIG. 4A is a schematic perspective view of a brushless motor using Hall elements, whereas FIG. 4B is a schematic illustration of the arrangement of the power supply lines and the signal lines.

### DESCRIPTION OF THE PREFERRED EMBODIMENT

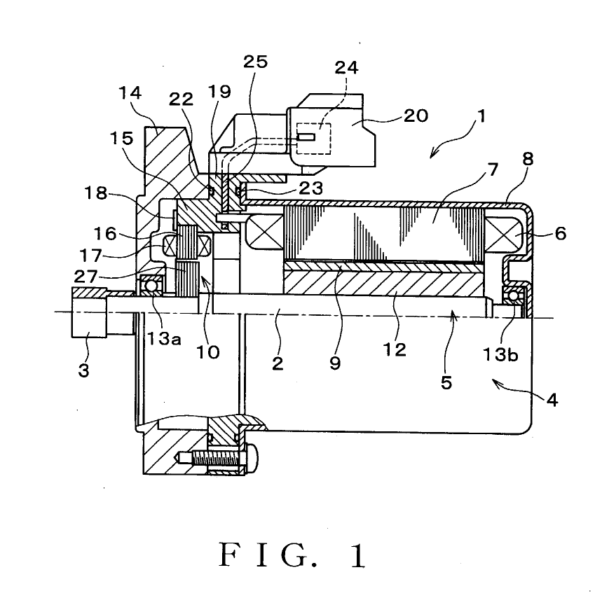

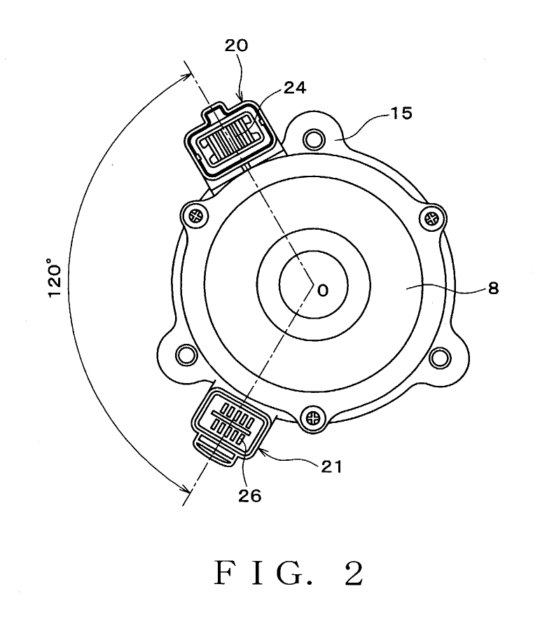

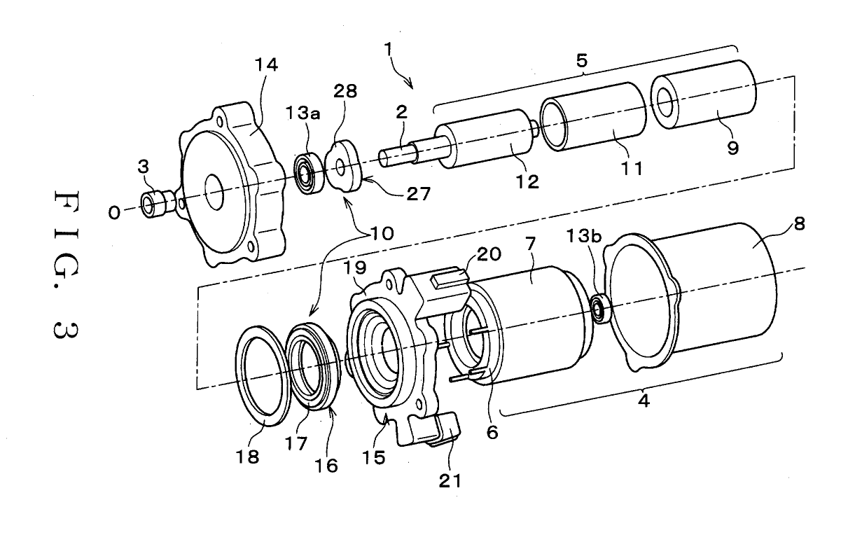

Now, the present invention will be described in greater detail by referring to the accompanying drawings that illustrate a preferred embodiment of the invention. FIG. 1 is a schematic partial cross sectional view of an embodiment of brushless motor 1 (to be referred to simple as motor 1 hereinafter) according to the invention, showing its configuration. FIG. 2 is a schematic lateral view of the embodiment of brushless motor of FIG. 1. FIG. 3 is an exploded schematic perspective view of the embodiment of brushless motor of FIG. 1.

Referring to FIG. 1, the motor 1 is used as a drive source of an electric power steering apparatus of an automobile and, as a driver operates a steering wheel of an automobile, it provides steering assistance force in accordance with a steering angle, a driving speed of a vehicle and other factors. More specifically, a rotor shaft 2 of the motor 1 is connected to an input shaft of a gearbox (not shown) via a coupler 3 and its revolutions per unit time is reduced appropriately in the gearbox and then transmitted to a steering column. The rotary motion of the steering column is converted into a reciprocating motion of a tie-rod in the rack-and-pinion type steering apparatus section to turn the steering wheels of the automobile. With this arrangement, the steering force is assisted by the rotary power of the motor 1 so that the driver can operate the steering wheel with relatively small force.

As shown in FIGS. 1 and 3, the motor 1 is an inner rotor type brushless motor in which a rotor 5 is rotatably arranged in the inside of a stator 4 and the rotary position of the rotor 5 can be detected by a resolver 10. The stator 4 includes a stator core 7 around which a drive coil 6 is wound and a metal-made case 8 containing the stator core 7. The stator core 7 is formed by laying a number of metal plates one on the other and has a drive coil 6 wound around a salient pole projecting at the inner peripheral side.

The rotor 5 includes a rotor shaft 2, a rotor magnet 9 rigidly fitted to the rotor shaft 2 and a magnet cover 11 arranged around the rotor magnet 9. A cylindrical rotor core 12 is formed on the rotor shaft 2 and the cylindrical rotor magnet 9 is rigidly secured to the outer periphery of the rotor core 12. The rotor shaft 2 is rotatably supported by a bracket 14 and the case 8 by way of respective bearings 13a, 13b. The bracket 14 is a member formed by aluminum die-casting and the bearing 13a is contained in and secured to a central area thereof. The case 8 is a cylindrical metal member and the bearing 13b is contained in and secured to a central area of an end thereof.

A resolver mount unit 15 that is made of synthetic resin is interposed between the bracket 14 and the case 8. A ring-shaped resolver stator 16 is fitted to the resolver mount unit 15. A coil 17 is wound around the resolver stator 16 to provide an excitation coil and a detection coil. The resolver stator 16 is prevented from being axially released by a stopper 18 that is contained in the resolver mount unit 15.

The resolver mount unit 15 includes a main body section 19 that is held tight between the bracket 14 and the case 8, a power supply line coupler (first coupler) 20 and a signal line coupler (second coupler) 21, the first and second couplers 20, 21 being integrally formed on the outer periphery of the main body section 19. The main body section 19, the bracket 14 and the case 8 are linked and held in an airtight condition by O-rings 22, 23. A power supply terminal 24 is contained in the power supply line coupler 20 and connected to a terminal plate 25 formed in the resolver mount unit 15 by insertion molding. The terminal plate 25 is connected to an end of the drive coil 6 so that the power supply terminal 24 and the drive coil 6 are electrically connected to each other. A signal terminal 26 is contained in the signal line coupler 21 and electrically connected to a terminal plate (not shown) formed in the resolver mount unit 15 by insertion molding. The terminal plate is connected to the resolver stator 16 so that the signal terminal 26 and the resolver stator 16 are electrically connected to each other.

Thus, in the motor 1, the power supply terminal 24 and the signal terminal 26 are turned into direct couplers, which are pinched between the bracket 14 and the case 8. Therefore, both the power supply lines and the signal lines can be assembled with an enhanced level of reliability and the number of man-hour can be reduced to by turn reduce the manufacturing cost. Further, since welding between lead wires and a terminal plate is unnecessary, the power supply line and the drive coil 6 are electrically connected easily. Additionally, since no rubber grommet is used in the motor, the bracket 14 and the case 8 are linked to the main body section by O-rings 22, 23 that have a simple profile and held in an airtight condition to improve the water resistance. Furthermore, the quality control of the product can be improved because the two couplers 20, 21 are made to be exclusively responsible for electric connections.

The power supply line coupler 20 and the signal line coupler 21 are arranged radially relative to the center O of the shaft of the rotor 5. In the above embodiment, the two couplers 20, 21 are arranged with an angular gap of 120°. In other words, the power supply lines and the signal lines are not juxtaposed but arranged in such a way that they are not unnecessarily too close relative to each other. With this arrangement, the power supply lines through which a relatively large electric current flows and the signal lines are separated from each other by a sufficiently large distance and hence the influence of the noises coming out of the power supply lines and exerted on the signals in the signal lines can be reduced. Therefore, rotor position detection errors due to noises are suppressed and the motor 1 can be driven efficiently to consequently reduce the torque ripple. In the case of the motor of an EPS, the torque ripple adversely affects the feeling of steering on the part of the operator and therefore the feeling will be remarkably improved when the torque ripple is suppressed.

A resolver rotor 27 that is rigidly secured to the rotor shaft 2 is arranged in the inside of the resolver stator 16 to form a complete resolver 10. The resolver rotor 27 is formed by laying metal plates in such a way that projections 28 are produced in three directions. As the rotor shaft 2 revolves, the resolver rotor 27 also revolves in the resolver stator 16. A high frequency signal is applied to the excitation coil of the resolver stator 16 and the phase of the signal output from the detection coil changes as the projections 28 approach and move away. The rotary position of the rotor shaft 2 is detected by comparing the detection signal and the reference signal.

Thus, the resolver 10 is hardly affected by external magnetic noises because it has a simple structure and hence durable and the method of detecting the rotary position of the rotor 5 consists in comparing the phase of the detection signal and that of the reference signal. Therefore, the present invention can improve the durability and the noise resistance of the motor. In other words, the present invention can improve the service life, the reliability and the controllability of the motor of an EPS that is used in a harsh operating environment. Additionally, the entire motor 1 can be made very compact because the resolver 10 is unitized and mounted in the motor 1.

At the same time, since the resolver 10 does not contain any semiconductor so that it can reliably withstand high temperature and vibrations. The resolver stator 16 can be molded with other components by using synthetic resin. For example, the resolver stator 16 can be formed in the resolver mount unit 15 by insertion molding. Then, since the resolver stator 16 is aligned in the mold and arranged in the resolver mount unit 15, dimensional errors that may be involved in the assembling operation are reduced to remarkably improve the positional accuracy of components including the resolver stator 16. Additionally, as the resolver stator 16 and the resolver mount unit 15 are integrally formed, the number of assembling steps is reduced to improve the productivity and reduce the cost. Furthermore, due to the enhanced degree of integration, the backlash of components is reduced to improve the shock-proof of the motor.

Components other than the resolver stator 16 and the resolver mount unit 15 may also be integrally formed. For example, the resolver mount unit 15 and the stator core 7, the resolver stator 16 and the bracket 14 and/or the resolver stator 16 and the case 8 may be integrally molded. If they are integrally molded, the bracket 14 and the case 8 are also made of synthetic resin.

Therefore, many of the components may be combined and integrally molded in many different ways. For example, the resolver stator 16, the resolver mount unit 15 and the stator core 7 may be integrally molded with or without the case 8. Alternatively, the resolver mount unit 15, the stator core 7 and the case 8 may be integrally molded. Still alternatively, the bracket 14, the resolver stator 16 and the resolver mount unit 15 may be integrally molded with or without stator core 7. When components are integrally molded, it is also possible to form the power supply line coupler 20 and the signal line coupler 21 at a site off the resolver mount unit 15, e. g., on the case 8.

With such integral molding, as described above by referring to the case of the resolver stator 16 and the resolver mount unit 15, dimensional errors that may be involved in the assembling operation are reduced to remarkably improve the positional accuracy of components including the resolver stator 16. Additionally, as a result of integral molding, the number of man-hour is reduced to improve the productivity and reduce the cost. Further, due to the enhanced degree of integration, the backlash of components is reduced to improve the shock-proof of the motor. Furthermore, when the stator core 7 is integrally formed with other components, it is protected against vibrations so that generation of magnetically distorted sound can be reduced.

Detailed description has hereinabove been given of the invention achieved by the present inventor with reference to the embodiment. However, the present invention should not be limited to the embodiment described above, and may be variously modified within the scope not departing from the gist.

For example, the power supply line coupler 20 and the signal line coupler 21 are arranged with an angular gap of 120° in the above described embodiment, they may alternatively be separated from each other by an angular gap of 180° and arranged point-symmetrically relative to the center O of the shaft of the rotor 5. If this is the case, the gap separating the two couplers is maximized to by turn maximize the noise reduction effect. It is also possible to arrange them with an angular gap of 90°. According to the findings obtained by the inventors of the present invention as a result of experiments, the two couplers are preferably separated from each other at least by an angular gap of 30°.

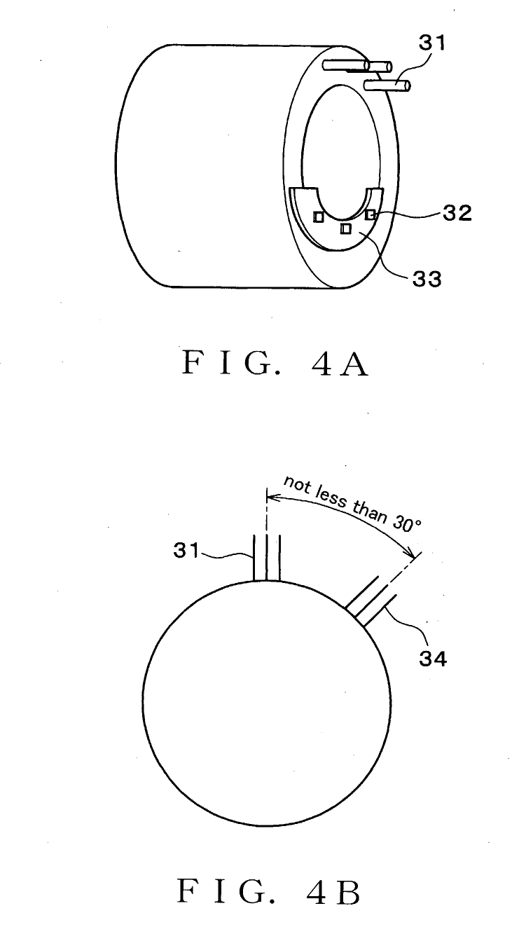

The above described arrangement of the power supply lines and the signal lines is effective when the rotary position of the rotor is detected not by means of a resolver but by means of Hall elements as illustrated in FIG. 4A. In the case of the motor illustrated in FIG. 4A, the power supply lines 31 are arranged at a position separated from the substrate 33 on which Hall elements 32 are mounted in order to reduce noises for the Hall elements 32. As shown in FIG. 4B, the signal lines 34 are arranged in a radial direction and separated from the power supply lines by an angular gap of not less than 30°. With this arrangement, the influence of the noises generated by the power supply lines 31 is reduced by means of the positioning of the Hall elements 32 and the signal lines 34.

While the motor 1 is an inner rotor type brushless motor, the present invention is also applicable to outer rotor type brushless motors from the viewpoint of power supply lines and signal lines. Furthermore, while the above described embodiment represents application of the present invention to a column-assist type electric power steering apparatus, the present invention is also applicable to an electric power steering apparatus of some other type such as rack-assist type. Additionally, the present invention has a broader scope of application including various industrial machines such as intelligent robots and IT equipments such as personal computers.

What is claimed is:

1. A brushless motor comprising:
a core provided with a drive coil wound around it;
a stator having a case for containing said core;
a bracket arranged at the side of an end of said case;
a rotor having a shaft rotatably supported by said case and said bracket and a magnet fitted to said shaft and rotatably arranged in the inside of said stator;
a resolver rotor fitted to said shaft and adapted to rotate with said magnet;
a resolver stator arranged at the outside of said resolver rotor and having a detection coil adapted to change the phase of its output signal as a function of the revolutions of said resolver rotor; and
a resolver mount unit made of synthetic resin and arranged between said case and said bracket to contain said resolver stator.

2. The brushless motor according to claim 1, wherein
said resolver mount unit includes a main body section made of synthetic resin and held between said case and said bracket, a first coupler molded integrally with said main body section and provided with a power supply terminal electrically connected to said drive coil and a second coupler molded integrally with said main body section and provided with a signal terminal electrically connected to said resolver stator.

3. The brushless motor according to claim 2, wherein
said first coupler and said second coupler is arranged in respective radial directions relative to the center of the shaft of said rotor.

4. The brushless motor according to claim 1, wherein
said resolver stator and said resolver mount unit are integrally molded.

5. The brushless motor according to claim 1, wherein
said resolver mount unit and said core are integrally molded.

6. The brushless motor according to claim 1, wherein said resolver stator and said bracket are integrally molded.

7. The brushless motor according to claim 1, wherein said core and said case are integrally molded.

8. The brushless motor according to claim 1, wherein said resolver stator, said case, said first coupler provided with the power supply terminal electrically connected to said drive coil and said second coupler provided with the signal terminal electrically connected to said resolver stator are integrally molded.

9. The brushless motor according to claim 8, wherein
said first coupler and said second coupler is arranged in respective radial directions relative to the center of the shaft of said rotor.

10. A brushless motor comprising:
a stator provided with a drive coil wound around it;
a rotor having a plurality of magnetic poles and arranged rotatably at the outer or inner periphery of said stator;
revolution detection means adapted to output a sensor signal in response to the revolutions of said rotor;
power supply lines electrically connected to said drive coil; and
signal lines electrically connected to said revolution detection means and arranged in a radial direction relative to the center of the shaft of said rotor with an angular gap separating it from said power supply lines.

11. The brushless motor according to claim 10, wherein
said power supply lines and said signal lines are arranged at respective positions that are point-symmetric relative to the center of the shaft of the rotor.

12. The brushless motor according to claim 10, wherein said power supply lines and said signal lines are arranged at respective positions that are rectangular relative to the center of the shaft of the rotor.

13. The brushless motor according to claim 10, wherein
said power supply lines and said signal lines are arranged with an angular gap of not less than 30° separating them from each other.

14. The brushless motor according to claim 10, wherein
said revolution detection means includes a resolver rotor that revolves with said rotor and a resolver stator provided with a detection coil adapted to change the phase of its output signal as a function of the revolution of said resolver rotor.

15. The brushless motor according to claim 10, wherein
said revolution detection means includes a sensor magnet having magnetic poles as many as the number of poles of said rotor and a magnetism detection element for detecting a change in the magnetic poles of said sensor magnet.

16. The brushless motor according to claim 1, wherein
said brushless motor is used as motor in an electric power steering apparatus.

17. The brushless motor according to claim 10, wherein
said brushless motor is used as motor in an electric power steering apparatus.
